(19) United States
(12) Patent Application Publication
(10) Pub. No.: US 2016/0253645 A1
(43) Pub. Date: Sep. 1, 2016

(54) POINT OF SALE SYSTEM WITH DATA ADAPTER

(71) Applicant: REVEL SYSTEMS, INC., San Francisco, CA (US)

(72) Inventors: Christopher CIABARRA, Sausalito, CA (US); Lisa FALZONE, San Francisco, CA (US)

(73) Assignee: REVEL SYSTEMS, INC., San Francisco, CA (US)

(21) Appl. No.: 15/149,928

(22) Filed: May 9, 2016

Related U.S. Application Data
(63) Continuation-in-part of application No. 15/043,163, filed on Feb. 12, 2016.
Application No. 15/043,163 is a continuation of application No. 13/227,397, filed on Sep. 7, 2011, now abandoned.
(60) Provisional application No. 62/159,199, filed on May 8, 2015.
(60) Provisional application No. 61/380,674, filed on Sep. 7, 2010.

(51) Int. Cl. G06Q 20/20; G06F 13/42

(52) U.S. Cl. CPC G06Q 20/20; G06F 13/4282

(57) ABSTRACT

Methods, systems, and computer program products for facilitating point-of-sale transactions and payment transactions using a data adapter device. In embodiments, a data adapter device receives a communication in first data protocol format and converts data from the communication into a second data protocol format.

### CROSS-REFERENCE TO RELATED APPLICATIONS

This patent application claims priority benefit under 35 USC §119(e) to co-pending and commonly-owned U.S. Pat. App. No. 62/159,199, filed on May 8, 2015, titled “POINT OF SALE SYSTEM WITH DATA ADAPTER,” listing Christopher Ciabarra as inventors, which patent document is incorporated by reference herein in its entirety and for all purposes.

This application is a continuation-in-part application and claims the priority benefit under 35 USC §120 to co-pending and commonly-owned of U.S. patent application Ser. No. 15/043,163, filed on Feb. 12, 2016, titled “POINT OF SALE SYSTEM,” with inventors Lisa Falzone and Christopher Ciabarra, which is a continuation application of and claims the priority benefit to U.S. patent application Ser. No. 13/227,397, filed on Sep. 7, 2011, titled “POINT OF SALE SYSTEM,” with inventors Lisa Falzone and Christopher Ciabarra, which claims priority from U.S. Prov. Pat. App. No. 61/380,674, filed on Sep. 7, 2010, titled “POINT OF SALE SYSTEM,” with inventors Lisa Falzone and Christopher Ciabarra; each of the foregoing patent applications is incorporated herein in its entirety by reference.

### BACKGROUND

A. Technical Field

Embodiments of the present invention generally relate to systems and methods for facilitating point of sale transactions and payment transactions.

B. Description of the Related Art

Various solutions exist today for conducting point of sale transactions in retail locations, restaurants, services establishments and other commercial environments. Some of these solutions rely on custom-built hardware technology that may be relatively expensive to purchase and maintain. Some of these solutions involve a relatively-low degree of technology integration or overreliance on human personnel activities, which may result in inefficient use of human resources and underutilization of technology potential.

Some point of sale systems deployed to manage commercial transactions employ wireless communications. It is often the case in such environments, however, that a multitude of overlapping wireless networks and signals lead to interference, security risks and system performance degradation, which can result in decreased system reliability, increased security threats, and diminished communication speeds and transaction efficiencies.

Consequently, there is a significant need in the industry for improved point of sale technology and services that rely on more standardized hardware resources, can decrease capital investments while enhancing operational efficiencies, and can improve system performance, reliability, and security.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 shows an exemplary point of sale system in accordance with various embodiments of the present disclosure.

FIG. 2 shows a representation of an exemplary data processing system that may be used in connection with various embodiments of the present disclosure.

FIG. 3 shows a point of sale system comprising a data processing system and a data adapter in accordance with various embodiments of the present disclosure.

FIG. 4 illustrates one or more peripheral devices communicating with a data processing system using data converted between a first data protocol and a standardized communication protocol in accordance with various embodiments of the present disclosure.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system/device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” and “comprising” shall be understood to be open terms and any lists the follow are examples and not meant to be limited to the listed items.

A service, function, or resource is not limited to a single service, function, or resource; usage of these terms may refer to a grouping of related services, functions, or resources, which may be distributed or aggregated.

The use of memory, database, information base, data store, tables, hardware, and the like may be used herein to refer to system component or components into which information may be entered or otherwise recorded.

The terms “data,” “information,” along with similar terms may be replaced by other terminologies referring to a group of bits, and may be used interchangeably. The terms “packet” or “frame” shall be understood to mean a group of bits that can be transported across a network. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.”

It shall be noted that the use of the terms “set” and “group” in this patent document shall include any number of elements.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims.

All publications, patents, and patent applications mentioned herein, if any, are incorporated by reference to the same extent as if each such individual publication, patent, or patent application were specifically and individually indicated to be incorporated by reference. To the extent that any inconsistency or conflict may exist between information expressly disclosed herein and information disclosed in any publications, patents, or patent applications that are incorporated by reference in this patent, the information expressly disclosed in this patent will take precedence and prevail.

While the specification concludes with claims defining the features of the invention that are regarded as novel, the invention will be better understood from a consideration of the following description in conjunction with the drawing figures, in which like reference numerals are carried forward.

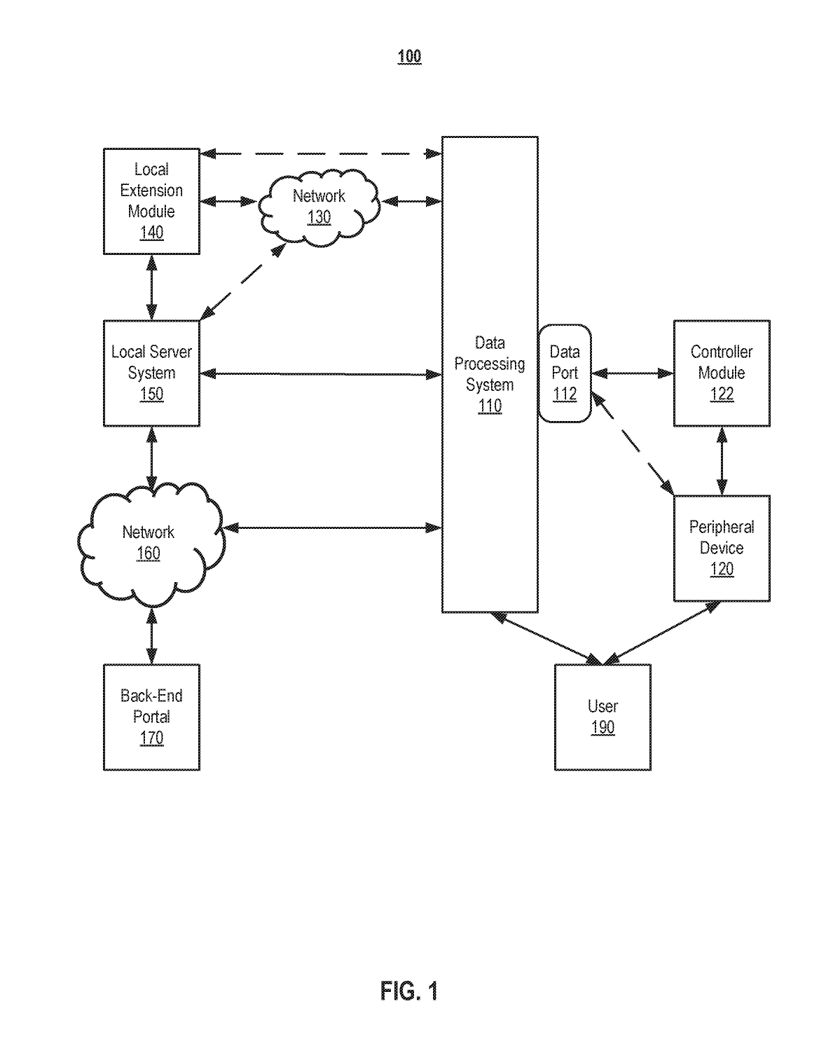

FIG. 1 shows an exemplary point of sale system in accordance with an embodiment.

Examples of point of sale (sometimes denoted “POS”) transactions that may be handled by various embodiments disclosed or claimed in this patent document include sales of items in retail environments (e.g., sale of a book in a bookstore, food item sales in a grocery store or quick service restaurant (QSR), conducting an Internet purchase or other Internet-based transaction from a stationary or mobile POS terminal), management of services and customer payments in a commercial establishment (e.g., conducting a restaurant transaction where a waiter processes orders from customers and handles corresponding payments), financial transactions (e.g., a bank representative handling a financial transaction for a customer), gas station transaction (e.g., where a customer purchases gas and/or items from a gas station mini-market), hotel transactions (e.g., checking a guest into a hotel room), and any other transaction that involves management of information transmitted between a customer and a merchant, handling of a payment for an item or service, and/or providing a good or service as part of a customer transaction.

The exemplary point of sale system illustrated in the embodiment of FIG. 1 includes a data processing system 110, a peripheral device 120, and a back-end portal 170.

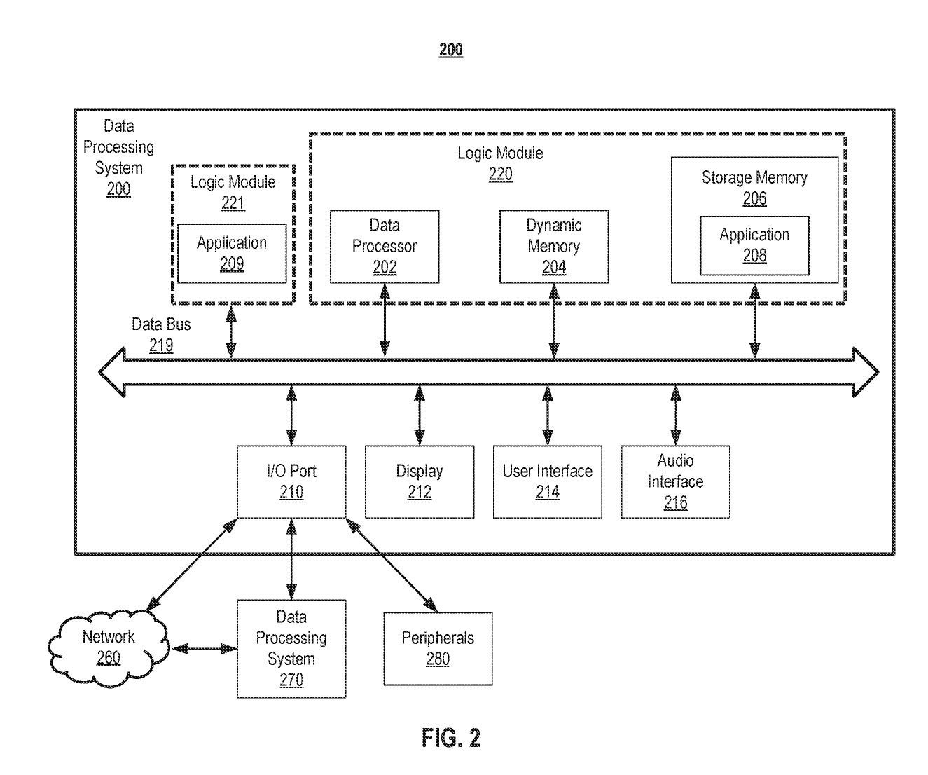

In one embodiment, the data processing system 110 is a tablet computer comprising a touch-sensitive (also denoted multi-touch-screen or touch-screen) display screen. In one implementation, the data processing system 110 is an iPad tablet computer currently commercialized by Apple Inc. In one implementation, the data processing system 110 is a tablet computer running the Android operating system currently developed by Google Inc. In one implementation, the data processing system 110 is a mobile phone. In one implementation, the data processing system 110 is any other device capable of conducting or facilitating a commercial transaction involving direct or indirect transmission of data. Further details regarding various embodiments of the data processing system 110 are provided in connection with the embodiment of FIG. 2.

In the embodiment of FIG. 1, the data processing system 110 comprises a data port 112. The data port 112 facilitates data transmissions between the data processing system 110 and the peripheral device 120, either directly or through a controller module 122.

The peripheral device 120 from the embodiment of FIG. 1 could perform a variety of functions in connection with point of sale transactions. In one implementation, the peripheral device 120 is a credit card reader that is configured to read a credit card, debit card, gift card, rewards card, points card, or any other card or tangible instrument for making, authorizing or confirming a payment, whether based on a magnetic stripe technology or on another contact or contactless technology. In one implementation, the peripheral device 120 is a barcode scanner configured to read barcode data. In one implementation, the peripheral device 120 is an RFID receiver configured to receive payment-related information from an RFID-enabled device. In one implementation, the peripheral device 120 is a receiver configured to receive payment-related information (e.g., from an electronic payment wallet or other electronic payment method) from a mobile phone or other personal device via a wireless transmission (e.g., using a WiFi connection, using a connection established over a cell phone network, using a BlueTooth connection, using a wireless USB connection, or using any other transmission protocol that may be implemented in a mobile phone or other personal communication device). In one implementation, the peripheral device 120 is a cash drawer adapted to hold cash. In one implementation, the peripheral device 120 is a scale adapted to weigh items. In one implementation, the peripheral device 120 is a printer adapted to print customer receipts for POS transactions, coupons, printed offers for customers, summaries of sales, or other documents relevant to the POS transactions conducted via the data processing system 110. In one implementation, the peripheral device 120 is a camera or other device capable of performing or facilitating image recognition (e.g., a camera or an optical scanner capable of identifying an object or person (examples of such objection include a tool being sold in a hardware store, a check being cashed in a bank, an application or other form being submitted in an administrative setting, etc.), identifying a human (e.g., verifying the identity of a customer making a payment), or interpreting other visual information (e.g., performing character recognition for information written on an object being sold). In one implementation, the peripheral device 120 is a photo camera or a video camera. In various implementations, the peripheral device 120 represents one or more such devices that are in direct or indirect communication with the data processing system 110 (e.g., there could be one, two or more peripheral devices 120).

In the embodiment of FIG. 1, a user 190 interacts with the peripheral device 120. For example, the user 190 could be a waiter that utilizes the peripheral device 120 (e.g., a credit card reader) to receive payment from a set of restaurant customers at the end of a meal. As another example, the user 190 could be a sales clerk in a convenience store that utilizes the peripheral device 120 (e.g., a barcode scanner) to process an object being purchased by a customer.

In one implementation, the peripheral device 120 is a representation of a combination of two or more peripheral devices. In one embodiment, there are more than one peripheral devices 120 coupled to the data processing system 110, in addition to the peripheral device 120 shown in the exemplary embodiment of FIG. 1. For example, a sales clerk in a grocery store could utilize in the course of one or more point of sale transactions a first peripheral device 120 comprising a barcode scanner to scan the price of an item and a second peripheral device 120 comprising a credit card reader to receive a credit card payment from a customer, with the information obtained by the barcode scanner and by the credit card reader being transmitted to the data processing system 110 either directly or through the controller 122.

Examples of information that could be included in a dataset communicated between the data processing system 110 (whether deployed as a mobile data processing system or as a fixed data processing system) and one or more peripheral devices (such as the peripheral device 120) include an identification marker of a food item, a price of a food item, an identification marker of a beverage item, a price of a beverage item, a price of a meal, a price of an item being sold, an identification marker of an item being sold, payment information (e.g., a credit card number, a payment approval token, identification of a customer conducting a POS transaction), or any other characteristic or attribute of any item that is the subject of a POS transaction and that is commonly used to identify and/or process that item. Such communication between a data processing system and a peripheral device may include direct or indirect transmission from the data processing system to the peripheral device and/or transmission from the peripheral device to the data processing system.

In general, a data processing system deployed as the data processing system 110 may include any data processing system that can be used to conduct a POS transaction (e.g., any electronic tablet such as an iPad or Android tablet, any mobile phone, any other portable or stationary computer, etc.). In one embodiment, the data processing system 110 is potentially mobile (i.e., the mobile data processing system could be removed from a docking station or other resting location and used to conduct a POS transaction in a portable operating mode).

In one embodiment, the peripheral device 120 shown in the exemplary embodiment of FIG. 1 comprises multiple peripheral devices (e.g., both a credit card reader and a touch-screen device that permits a waiter to input information regarding an order placed by a restaurant guest, a scale adapted to weigh items that also includes a barcode reader, etc.).

In one embodiment, the peripheral device 120 shown in the exemplary embodiment of FIG. 1 consists of a single integrated unit that is capable of performing the functions of multiple peripheral devices (e.g., the peripheral device 120 could incorporate both credit card reader functionality and bar code reader functionality).

In one embodiment, the peripheral device 120 shown in the exemplary embodiment of FIG. 1 is incorporated into, or is integrated with the data processing system 110 (e.g., a credit card reader may be integrated together with an electronic tablet device to produce an integrated unit that includes both touch-screen tablet functionality and payment processing capability).

In one embodiment, the peripheral device 120 transmits information received as part of the point of sale transaction to the data processing system 110 immediately (e.g., a credit card reader would transmit the credit card information upon the card being swiped). In one embodiment, the peripheral device 120 transmits information received as part of the point of sale transaction to the data processing system 110 at a later time (e.g., a credit card reader could buffer and store information regarding the credit cards swiped until a later time, for example until the credit card reader is docked via a wired connection to the data processing system 110 or is in closer proximity with the data processing system 110 or with a wireless router capable of transmitting the payment data to the data processing system 110.

In one embodiment, the controller 122 mediates information transmitted between the peripheral device 120 and the data processing system 110. In one embodiment, the controller module 122 receives information formatted in accordance with a first data protocol from the peripheral device 120, converts at least part of such information into information formatted in accordance with a second data protocol, and then transmits at least part of the information formatted in accordance with the second data protocol to the data processing system 110. In one implementation, the controller module 122 converts information received through a USB connection from the peripheral device 120 to serial data, and then sends at least part of the converted serial data to the data port 112 of the data processing system 110.

In one embodiment, the controller module 122 is a networking device, such as a WiFi router, wired router, switch (e.g., an Ethernet switch), gateway, or another networking device that allows one or more devices to communicate with each other using wireless or wired connections.

More details regarding various embodiments of the controller module 122 are provided in the U.S. patent application Ser. No. 13/227,397.

In one embodiment, the controller module 122 is integrated in the peripheral device 120. In one embodiment, the controller module 122 is integrated in the data processing system 110. In one embodiment, the controller module 122 is a stand-alone unit coupled to the peripheral device 120 and the data processing system 110 through one or more communication channels or data networks. In one embodiment, the controller module 122 is a stand-alone unit that could be coupled to the peripheral device 120 through a wired communication channel and to the data processing system 110 through a wireless communication channel (whether at the same time or at different times).

In various embodiments, the connection between one or more peripheral devices 120 and the data processing system 110 could be wired or wireless. In one implementation, a controller module 122 is connected via a USB connection to the peripheral device 120 and via a wireless connection to the data processing system 110. In one implementation, a controller module 122 is connected via a USB connection to the peripheral device 120 and via a serial, wired connection to the data processing system 110. In one implementation, a controller module 122 is connected via an Ethernet connection or other wireline connection to the peripheral device 120 and via an Ethernet connection or other wireline connection to the data processing system 110. In one implementation, a controller module 122 is connected via one or more wireless networks (e.g., WiFi, cellular phone and/or data network, etc.) and/or via one or more wireless communication channels (e.g., wired USB connection, wireless USB connection, and/or Bluetooth connection, etc.) to both the peripheral device 120 and the data processing system 110.

In one implementation, a controller module 122 is connected via a combination of one or more wireless networks (e.g., WiFi, cellular phone and/or data network, etc.), one or more wireless communication channels (e.g., wired USB connection, wireless USB connection, and/or Bluetooth connection, etc.), and/or one or more Ethernet connection or other wireline connection to both the peripheral device 120 and the data processing system 110. For example, a controller module 122 may be connected via an Ethernet connection to the peripheral device 120, with a WiFi wireless connection acting as a backup connection to the peripheral device 120, while the controller module 122 is also connected via an Ethernet connection to the peripheral device 120 (which may also be backed up by a wireless connection).

In the embodiment of FIG. 1, the data processing system 110 receives information from the peripheral device 120, directly and/or through the controller module 122, and utilizes at least part of the received information to facilitate the respective point of sale transaction. For example, the data processing system 110 could run a software program that processes payment data received from a credit card reader deployed as peripheral device 120 and correlates such payment data with additional information entered by the user 190 regarding the respective transaction (e.g., correlate payment information with a restaurant order and bill entered by a restaurant waiter into the data processing system 110).

In one embodiment, the user 190 (e.g., a sales clerk conducting a sale in a retail or grocery store, a waiter, or another person conducting a POS transaction) with the data processing system 110 by entering information directly into the data processing system 110 (e.g., via a graphical user interface provided by a display integrated into the data processing system 110 or otherwise connected with the data processing system 110). For example, a restaurant waiter could carry the data processing system 110 (e.g., a mobile touch-screen device) to a table, then use a graphical user interface shown on the touch-screen to enter information about the various food and beverage selections made by customers sitting at that table, and later use a graphical user interface shown on the touch-screen of the data processing system 110 and/or the peripheral device 120 to generate a final bill and process a payment from the respective customers).

In one embodiment, the user 190 interacts with the data processing system 110 by entering information into the data processing system 110 through a peripheral device 120 that includes data input capabilities (e.g., a portable palm-sized touch-screen portable terminal with a suitable graphical user interface, a portable terminal comprising an LCD display that further comprises a keyboard). For example, in a restaurant, a waiter may not carry the data processing system 110 to a table, but may instead rely on a smaller mobile terminal deployed as the peripheral device 120 (e.g., a touch-screen device the size of a smartphone) to enter and process orders from the respective customers.

In one embodiment, upon processing information received from the peripheral device 120 and/or the user 190, the data processing system 110 transmits processed information to a local extension module 140, a local server system 150, and/or a back-end portal 170.

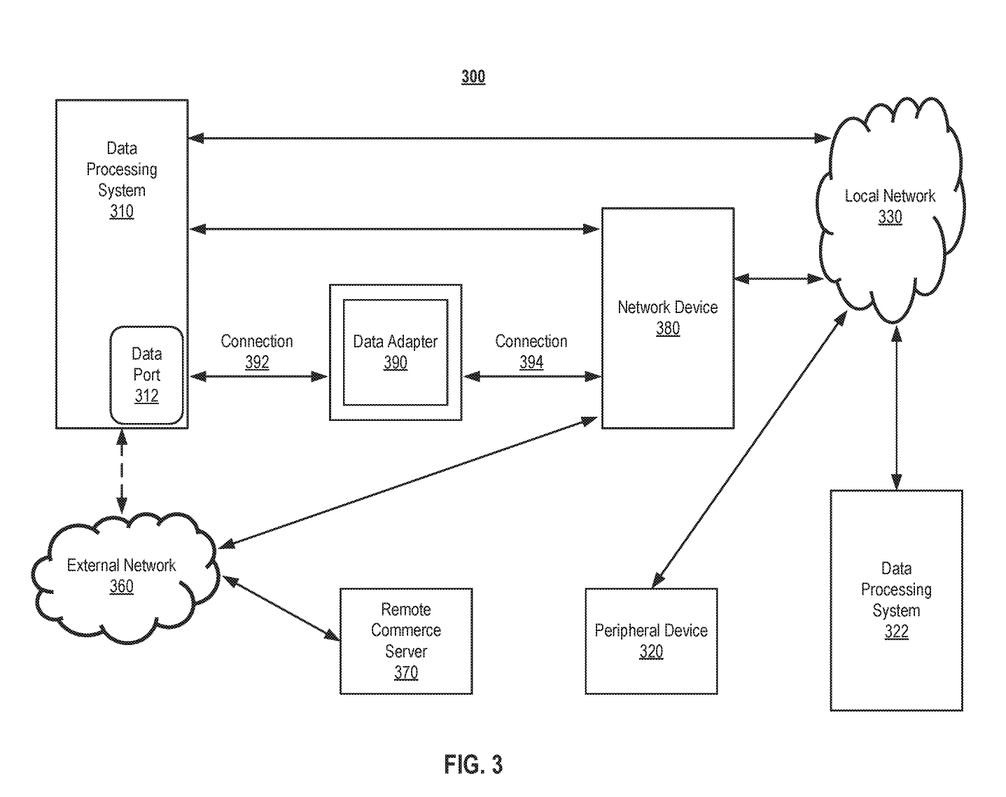

In one embodiment, the local extension module 140 is a peripheral device that provides support for point of sale transactions, such as printing information, storing data, scanning documents, faxing documents, or buffering data for further transmission to other local or remote devices. In one embodiment, the local extension module 140 is a printer that can print out or otherwise generate receipts, records of transactions, bills, invoices or any other documents or information produced or processed by the data processing system 110 or by the local server system 150. In one embodiment, the local extension module 140 (e.g., a printer, a logic module, a computer, or another data processing system) is configured to open a cash drawer incorporated in the local server system 150. Opening the cash drawer in this embodiment may take place automatically (e.g., automatically triggered by a specific printing transaction), or may be initiated independently by an instruction transmitted by the data processing system 110. Further details regarding data communications between the local extension module 140 and the data processing system 110 in accordance with an embodiment of the invention are provided in connection with the embodiment of FIG. 3.

In various embodiments, the local extension module 140 may consist of a stand-alone device with substantially singular functionality (e.g., a printer), an integrated data processing system with multiple functionalities (e.g., an integrated business center system that includes copier, scanner, faxing and/or printing functionality), or a combination of such stand-alone devices and/or integrated devices. In one embodiment, the local extension module 140 is a display that shows to a retail representative and/or to a customer details regarding the point of sale transaction (e.g., the names, numbers and prices of items being sold in a grocery store).

In various embodiments, the data processed by the local extension module 140 may be obtained from the data processing system 110 or from the local server system 150.

In one embodiment, the local extension module 140 may be implemented as a peripheral device 120, as discussed above.

In one embodiment, the local server system 150 is a data processing system that provides support for point of sale transactions, such as acting as a local server, storing or buffering data, providing network administration and/or security functionality, routing electronic traffic between external systems and the data processing system 110 or other local devices (e.g., a gateway or router), providing cash register functionality (e.g., managing hard currency transactions and issuance of change in bills and coins), and detecting, preventing and reporting fraud.

In one embodiment, the local server system 150 is a cash register coupled to the data processing system 110 through a docking station. In various implementations, a docking station could provide a place for a mobile device deployed as the data processing system 110 to be placed for recharging, temporary storage, or for handling point of sale transactions in a stationary configuration. In one implementation, a docking station provides a locking mechanism (e.g., a direct connector, a steel cable, a sensor device, etc.) to secure the data processing system 110 against theft or other tempering. An example of a data processing system 110 comprising an iPad tablet computer commercialized by Apple Inc. that is configured to conduct a point of sale transaction by being coupled with a local server system 150 comprising a cash register is shown in the U.S. patent application Ser. No. 13/227,397.

Communications between the data processing system 110, the local extension module 140 and/or a local server system 150 could take place via a network 130 (e.g., a wired local area network (LAN) or a WiFi wireless network), via one or more communication channels (e.g., wired and/or wireless USB connections, Bluetooth connection), or via a combination of networks and communication channels. Such communications could be non-encrypted, encrypted, or using any other security or proprietary protocol. In general, communications between various elements shown in FIG. 1 could take place over any combination of such networks or communication channels. Additional discussion of data networks and communication channels is provided in connection with the embodiment of FIG. 2.

In general, any particular connection between elements shown in the embodiment of FIG. 1 could be implemented using alternative routes or data protocols. For example, the connection between the data processing system 110 and the local server system 150 could be achieved directly, through the network 130, through the local extension module 140 (the connection between the data processing system 110 and the local extension module 140 is shown with a dotted line in FIG. 1 to suggest that it could be an optional connection, but in general to the extent that any particular connection is replaceable, that particular connection could be considered optional), or through both the network 130 and the local extension module 140. When acting as an intermediate device in a connection between two or more other devices, any element shown in the embodiment of FIG. 1 could pass information through unchanged or could process or otherwise convert some or all of that information before relaying it further. In one embodiment, communications between two or more of the elements shown in FIG. 1 are encrypted, and the respective devices include logic modules (e.g., software) adapted to decrypt and/or encrypt data.

In one embodiment, the local server system 150 transmits information regarding the point of sale transaction to a remote commerce server or a back-end portal 170. Such information may include payment information provided by the user 190 in an attempt to validate that information and secure payment from a financial institution to complete the respective point of sale transaction. For example, the local server system 150 could transmit a credit card payment request to the remote commerce server or to a back-end portal 170 after the credit card of the user 190 was swiped through the peripheral device 120.

In one embodiment, the data processing system 110 may itself directly transmit information regarding the point of sale transaction to a remote commerce server or to the back-end portal 170, without the assistance of the local server system 150. This may happen, for example, if the relevant functionality of the local sever system 150 is implemented directly in the data processing system 110, or in a case where the local server system 150 is configured to act as an intermediary in the course of normal operation but becomes temporarily unavailable and the data processing system 110 is able to communicate with a remote commerce server or the back-end portal 170 directly).

In one embodiment, the information transmitted by the data processing system 110 and/or the local system 150 to a remote commerce server or to the back-end portal 170 in connection with a point of sale transaction includes payment data provided by the user 190 in an attempt to secure payment from a financial institution to complete the respective point of sale transaction. For example, the data processing system 110 could transmit a credit card payment request to a remote commerce server or to the back-end portal 170 after the credit card of the user 190 was swiped through the peripheral device 120.

Communications with a remote commerce server or the back-end portal 170 may take place via a network 160 (e.g., the Internet, a cellular data network, etc.). Further examples of suitable data networks are provided in connection with the embodiment of FIG. 2.

In one embodiment, a remote commerce server or the back-end portal 170 is a data processing system that is configured to manage financial transactions in support of point of sale transactions conducted at remote locations, such as point of sale transactions conducted using the data processing system 110. In one embodiment, a remote commerce server or the back-end portal 170 relays to a financial institution (not shown in FIG. 1) a credit card payment request from the data processing system 110 and/or the local server system 150 regarding a purchase made by the user 190, then receives a payment authorization from the financial institution, and then relays the respective payment authorization to the data processing system 110 to indicate that the purchase by the user 190 has been funded. In one embodiment, a remote commerce server or the back-end portal 170 does not relay payment requests to any external financial institutions, but is instead configured to directly approve or decline the respective payment requests (e.g., when the remote commerce server or back-end portal 170 is itself operated by an entity that has the ability to authorize financial payments).

In one embodiment, the back-end portal 170 is protected with various security layers. In one implementation, the back-end portal 170 is protected with a software security system that locks IP addresses and prevents unauthorized third parties from accessing the back-end portal 170. In one implementation, each of the data processing systems 110 from various point of system locations has an authentication code, possibly unique, and the back-end portal 170 is configured to only accept connections from devices that provide the respective authentication codes. By eliminating or restricting connections initiated by unauthorized devices, the back-end portal 170 experiences a higher degree of security.

In one embodiment, the back-end portal 170 is a cloud system that stores information relating to POS transactions conducted via the data processing system 110 and/or facilitates POS transactions conducted via the data processing system 110.

In one embodiment the back-end portal 170 includes a cloud-based portal through which a merchant may access data relating to the transactions processed through one or more data processing systems 110 deployed in one or more locations operated by that merchant. In various embodiments, the data that may be accessed by a merchant through the back-end portal 170 includes real time sales data collected from one or more data processing systems 110, historical sales data for one or more data processing systems 110 and/or one or more locations of the merchant, stockkeeping unit (“SKU”)-level data relating to items sold (e.g., the description and price of individual items sold by a data processing system 110), inventory management information (e.g., current and projected levels of items in the inventory of the merchant), profitability analysis for various items sold by the merchant, customer relationship management (“CRM”) information relating customers of the merchant purchasing items via one or more data processing systems 110, ingredient management information for ingredients used to manufacture end products sold in a food establishment, and other similar types of information relevant to transactions conducted by a merchant in one or more locations.

In one embodiment, a single retail location (e.g., a restaurant or store) has a plurality of data processing systems 110 (e.g., two or more restaurant mobile terminals, two or more store retail registers, etc.), and the various data processing systems 110 are configured to communicate with each other and/or with the various other elements shown in FIG. 1. For example, a waiter in a restaurant may utilize a particular data processing system 110 to receive an order from a group of customers, and then may utilize another data processing system 110 to update the order and/or to generate a final bill. In one embodiment, there are a plurality of data processing systems corresponding to various other elements shown in FIG. 1 (e.g., a retail location may have two or more local extension modules 140, two or more local server systems 150, etc.). In one embodiment, the functionality of various elements shown in FIG. 1 is integrated in a data processing system 110 (e.g., a restaurant mobile terminal could include the functionality of the local server system 150 and may be able to communicate with a remote commerce server or the back-end portal 170 over the network 160. In general, incorporating additional functionality in data processing system 110 may increase the cost of each such device, but may also provide improved reliability for the respective POS retail system by increasing the redundancies and failure resilience of the POS retail system.

FIG. 2 shows a representation of an exemplary data processing system 200 that may be used in connection with various embodiments described and/or claimed in this patent and which may be configured to execute instructions for performing functions and methods described and/or claimed in this patent. In one implementation, the data processing system 200 represents the data processing system 110 from the embodiment of FIG. 1. In one implementation, the data processing system 200 is a tablet computer comprising a multi-touch display sensitive screen, such as an iPad tablet computer currently commercialized by Apple Inc., a tablet computer running the Android operating system currently developed by Google Inc., a mobile phone, or another mobile personal communication device. In various implementations, the data processing system 200 may be the peripheral device 120, local server system 150 and/or the back-end portal 170 from the embodiment of FIG. 1.

The exemplary data processing system 200 includes a data processor 202. The data processor 202 represents one or more general-purpose data processing devices such as a microprocessor or other central processing unit. More particularly, the processing device may be a complex instruction set computing (CISC) microprocessor, a reduced instruction set computing (RISC) microprocessor, a very long instruction word (VLIW) microprocessor, a processor implementing other instruction sets, or a processor implementing a combination of instruction sets, whether in a single core or in a multiple core architecture. Data processor 202 may also be or include one or more special-purpose processing devices such as an application specific integrated circuit (ASIC), a field programmable gate array (FPGA), a digital signal processor (DSP), network processor, any other embedded processor, or the like. The data processor 202 may execute instructions for performing operations and steps in connection with various embodiments of the present invention.

In this exemplary embodiment, the data processing system 200 further includes a dynamic memory 204, which may be designed to provide higher data read speeds. Examples of dynamic memory 204 include dynamic random access memory (DRAM), synchronous DRAM (SDRAM) memory, read-only memory (ROM) and flash memory. The dynamic memory 204 may be adapted to store all or part of the instructions of a software application, as these instructions are being executed or may be scheduled for execution by data processor 202. In some implementations, the dynamic memory 204 may include one or more cache memory systems that are designed to facilitate lower latency data access by the data processor 202.

In general, unless otherwise stated or required by the context, when used in this patent in connection with a method or process, data processing system, or logic module, the words “adapted” and “configured” are intended to describe that the respective method, data processing system or logic module is capable of performing the respective functions by being appropriately adapted or configured (e.g., via programming, via the addition of relevant components or interfaces, etc.), but are not intended to suggest that the respective method, data processing system or logic module is not capable of performing other functions. For example, unless otherwise expressly stated, a logic module that is described as being adapted to process a specific class of information will not be construed to be exclusively adapted to process only that specific class of information, but may in fact be able to process other classes of information and to perform additional functions (e.g., receiving, transmitting, converting, or otherwise processing or manipulating information).

In this exemplary embodiment, the data processing system 200 further includes a storage memory 206, which may be designed to store larger amounts of data. Examples of storage memory 206 include a magnetic hard disk and a flash memory module. In various implementations, the data processing system 200 may also include, or may otherwise be configured to access one or more external storage memories, such as an external memory database or other memory data bank, which may either be accessible via a local connection (e.g., a wired or wireless USB, Bluetooth, or WiFi interface), or via a network (e.g., a remote cloud-based memory volume).

A storage memory may also be denoted a memory medium, storage medium, dynamic memory, or memory. In general, a storage memory, such as the dynamic memory 204 and the storage memory 206, may include any chip, device, combination of chips and/or devices, or other structure capable of storing electronic information, whether temporarily, permanently or quasi-permanently. A memory medium could be based on any magnetic, optical, electrical, mechanical, electromechanical, MEMS, quantum, or chemical technology, or any other technology or combination of the foregoing that is capable of storing electronic information. A memory medium could be centralized, distributed, local, remote, portable, or any combination of the foregoing. Examples of memory media include a magnetic hard disk, a random access memory (RAM) module, an optical disk (e.g., DVD, CD), and a flash memory card, stick, disk or module.

A software application or module, and any other computer executable instructions, may be stored on any such storage memory, whether permanently or temporarily, including on any type of disk (e.g., a floppy disk, optical disk, CD-ROM, and other magnetic-optical disks), read-only memory (ROM), random access memory (RAM), EPROM, EEPROM, magnetic or optical card, or any other type of media suitable for storing electronic instructions.

In general, a storage memory could host a database, or a part of a database. Conversely, in general, a database could be stored completely on a particular storage memory, could be distributed across a plurality of storage memories, or could be stored on one particular storage memory and backed up or otherwise replicated over a set of other storage memories. Examples of databases include operational databases, analytical databases, data warehouses, distributed databases, end-user databases, external databases, hypermedia databases, navigational databases, in-memory databases, document-oriented databases, real-time databases and relational databases.

Storage memory 206 may include one or more software applications 208, in whole or in part, stored thereon. In general, a software application, also denoted a data processing application or an application, may include any software application, software module, function, procedure, method, class, process, or any other set of software instructions, whether implemented in programming code, firmware, or any combination of the foregoing. A software application may be in source code, assembly code, object code, or any other format. In various implementations, an application may run on more than one data processing system (e.g., using a distributed data processing model or operating in a computing cloud), or may run on a particular data processing system or logic module and may output data through one or more other data processing systems or logic modules.

The exemplary data processing system 200 may include one or more logic modules 220 and/or 221, also denoted data processing modules, or modules. Each logic module 220 and/or 221 may consist of (a) any software application, (b) any portion of any software application, where such portion can process data, (c) any data processing system, (d) any component or portion of any data processing system, where such component or portion can process data, and (e) any combination of the foregoing. In general, a logic module may be configured to perform instructions and to carry out the functionality of one or more embodiments of the present invention, whether alone or in combination with other data processing modules or with other devices or applications. Logic modules 220 and 221 are shown with dotted lines in FIG. 2 to further emphasize that data processing system 200 may include one or more logic modules, but does not have to necessarily include more than one logic module.

As an example of a logic module comprising software, logic module 221 shown in FIG. 2 consists of application 209, which may consist of one or more software programs and/or software modules. Logic module 221 may perform one or more functions if loaded on a data processing system or on a logic module that comprises a data processor.

As an example of a logic module comprising hardware, the data processor 202, dynamic memory 204 and storage memory 206 may be included in a logic module, shown in FIG. 2 as exemplary logic module 220. Examples of data processing systems that may incorporate both logic modules comprising software and logic modules comprising hardware include a desktop computer, a mobile computer, or a server computer, each being capable of running software to perform one or more functions defined in the respective software.

In general, functionality of logic modules may be consolidated in fewer logic modules (e.g., in a single logic module), or may be distributed among a larger set of logic modules. For example, separate logic modules performing a specific set of functions may be equivalent with fewer or a single logic module performing the same set of functions. Conversely, a single logic module performing a set of functions may be equivalent with a plurality of logic modules that together perform the same set of functions. In the data processing system 200 shown in FIG. 2, logic module 220 and logic module 221 may be independent modules and may perform specific functions independent of each other. In an alternative embodiment, logic module 220 and logic module 221 may be combined in whole or in part in a single module that perform their combined functionality. In an alternative embodiment, the functionality of logic module 220 and logic module 221 may be distributed among any number of logic modules. One way to distribute functionality of one or more original logic modules among different substitute logic modules is to reconfigure the software and/or hardware components of the original logic modules. Another way to distribute functionality of one or more original logic modules among different substitute logic modules is to reconfigure software executing on the original logic modules so that it executes in a different configuration on the substitute logic modules while still achieving substantially the same functionality. Examples of logic modules that incorporate the functionality of multiple logic modules and therefore can be construed themselves as logic modules include system-on-a-chip (SoC) devices and a package on package (PoP) devices, where the integration of logic modules may be achieved in a planar direction (e.g., a processor and a storage memory disposed in the same general layer of a packaged device) and/or in a vertical direction (e.g. using two or more stacked layers).

The exemplary data processing system 200 may further include one or more input/output (I/O) ports 210 for communicating with other data processing systems 270, with other peripherals 280, or with one or more networks 260. Each I/O port 210 may be configured to operate using one or more communication protocols. In general, each I/O port 210 may be able to communicate through one or more communication channels. The data processing system 200 may communicate directly with other data processing systems 270 (e.g., via a direct wireless or wired connection), or via the one or more networks 260.

A communication channel may include any direct or indirect data connection path, including any connection using a wireless technology (e.g., Bluetooth, infrared, WiFi, WiMAX, cellular, 3G, 4G, EDGE, CDMA and DECT), any connection using wired (also sometimes denoted “wireline”) technology (including via any serial, parallel, wired packet-based communication protocol (e.g., Ethernet, USB, FireWire, etc.), or other wireline connection), any optical channel (e.g., via a fiber optic connection or via a line-of-sight laser or LED connection), and any other point-to-point connection capable of transmitting data.

Each of the networks 260 may include one or more communication channels. In general, a network, or data network, consists of one or more communication channels. Examples of networks include LANs, MANs, WANs, cellular and mobile telephony networks, the Internet, the World Wide Web, and any other information transmission network. In various implementations, the data processing system 200 may include interfaces and communication ports in addition to the I/O ports 210.

In various embodiments, a network, such as network 260, may include a collection of terminal nodes, links and any intermediate nodes. A network maybe wired or wireless. An example of a wired network is an Ethernet network. An example of a wireless network is a WiFi network.

The exemplary data processing system 200 may further include a display 212, which provides the ability for a user to visualize data output by the data processing system 200 and/or to interact with the data processing system 200. The display 212 may directly or indirectly provide a graphical user interface (GUI) adapted to facilitate presentation of data to a user and/or to accept input from a user. The display 212 may consist of a set of visual displays (e.g., an integrated LCD, LED or CRT display), a set of external visual displays, (e.g., an LCD display, an optical projection device, a holographic display), or of a combination of the foregoing.

A visual display may also be denoted a graphic display, computer display, display, computer screen, screen, computer panel, or panel. Examples of displays include a computer monitor, an integrated computer display, electronic paper, a flexible display, a touch panel, a transparent display, and a three-dimensional (3D) display that may or may not require a user to wear assistive 3D glasses.

A data processing system may incorporate a graphic display. Examples of such data processing systems include a laptop, a computer pad or notepad, a tablet computer, an electronic reader (also denoted an e-reader or ereader), a smart phone, a personal data assistant (PDA).

A data processing system may be connected to an external graphic display. Examples of such data processing systems include a desktop computer, a server, an embedded data processing system, or any other data processing system that does not itself include a display but which produces data that may be shown to a user. A data processing system that incorporates a graphic display may also be connected to an external display. A data processing system may directly display data on an external display, or may transmit data to other data processing systems or logic modules that will eventually display data on an external display.

Graphic displays may include active display, passive displays, LCD displays, LED displays, OLED displays, plasma displays, and any other type of visual display that is capable of displaying electronic information to a user. Such graphic displays may permit direct interaction with a user, either through direct touch by the user (e.g. a touch-screen display that can sense a user's finger touching a particular area of the display), through proximity interaction with a user (e.g., sensing a user's finger being in proximity to a particular area of the display), or through a stylus or other input device. In one implementation, the display 212 is a touch-screen display that displays a human GUI interface to a user, with the user being able to control the data processing system 200 through the human GUI interface, or to otherwise interact with, or input data into the data processing system 200 through the human GUI interface.

The exemplary data processing system 200 may further include one or more human input interfaces 214, which facilitate data entry by a user or other interaction by a user with the data processing system 200. Examples of human input devices 214 include a keyboard, a mouse (whether wired or wireless), a stylus, other wired or wireless pointer devices (e.g., a remote control), or any other user device capable of interfacing with the data processing system 200. In some implementations, human input devices 214 may include one or more sensors that provide the ability for a user to interface with the data processing system 200 via voice, or provide user intention recognition technology (including optical, facial, or gesture recognition), or gesture recognition (e.g., recognizing a set of gestures based on movement via motion sensors such as gyroscopes, accelerometers, magnetic sensors, optical sensors, etc.).

The exemplary data processing system 200 may further include one or more gyroscopes, accelerometers, magnetic sensors, optical sensors, or other sensors that are capable of detecting physical movement of the data processing system. Such movement may include larger amplitude movements (e.g., a device being lifted by a user off a table and carried away or elevation changes experienced by the data processing system), smaller amplitude movements (e.g., a device being brought closer to the face of a user or otherwise being moved in front of a user while the user is viewing content on the display, movement experienced by a vehicle within which the data processing system is located), or higher frequency movements (e.g., hand tremor of a human, vibrations caused by an engine). In the absence of internal motion sensors, or in addition to any internal motion sensors, the exemplary data processing system 200 may further be capable of receiving and processing information from external motion sensors such as gyroscopes, accelerometers, magnetic sensors, optical sensors, or other sensors that are capable of detecting physical movement of the data processing system.

The exemplary data processing system 200 may further include an audio interface 216, which provides the ability for the data processing system 200 to output sound (e.g., a speaker), to input sound (e.g., a microphone), or any combination of the foregoing.

The exemplary data processing system 200 may further include any other components that may be advantageously used in connection with receiving, processing and/or transmitting information.

In the exemplary data processing system 200, the data processor 202, dynamic memory 204, storage memory 206, I/O port 210, display 212, human input interface 214, audio interface 216, and logic module 221 communicate to each other via the data bus 219. In some implementations, there may be one or more data buses in addition to the data bus 219 that connect some or all of the components of data processing system 200, including possibly dedicated data buses that connect only a subset of such components. Each such data bus may implement open industry protocols (e.g., a PCI or PCI-Express data bus), or may implement proprietary protocols.

Some of the embodiments described in this specification may be presented in terms of algorithms and symbolic representations of operations on data bits within a computer memory. In general, an algorithm represents a sequence of steps leading to a desired result. Such steps generally require physical manipulations of physical quantities. Usually, though not necessarily, these quantities take the form of electrical or magnetic signals capable of being stored, transferred, combined, compared, and otherwise manipulated using appropriate electronic devices. Such signals may be denoted as bits, values, elements, symbols, characters, terms, numbers, or using other similar terminology.

When used in connection with the manipulation of electronic data, terms such as processing, computing, calculating, determining, displaying, or the like, refer to the action and processes of a computer system or other electronic system that manipulates and transforms data represented as physical (electronic) quantities within the system's registers and memories into other data similarly represented as physical quantities within the memories or registers of that system of or other information storage, transmission or display devices.

Various embodiments of the present invention may be implemented using an apparatus or machine that executes programming instructions. Such an apparatus or machine may be specially constructed for the required purposes, or may comprise a general purpose computer selectively activated or reconfigured by a software application.

Algorithms discussed in connection with various embodiments of the present invention are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description provided in connection with the various embodiments discussed in this patent. In addition, embodiments of the present invention are not described with reference to any particular programming language, data transmission protocol, or data storage protocol. Instead, a variety of programming languages, transmission or storage protocols may be used to implement various embodiments of the invention.

FIG. 3 shows a point of sale system comprising a data processing system and a network adapter in accordance with an embodiment of the invention. In one embodiment, the point of sale system shown in FIG. 3 is adapted to facilitate a POS transaction.

In the embodiment of FIG. 3, a data processing system 310 is configured to conduct POS transactions and to communicate with a networking device 380. In one embodiment, the data processing system 310 is the data processing system 110 from FIG. 1. In one embodiment, the data processing system 310 is the data processing system 200 from FIG. 2.

In one embodiment, the data processing system 310 comprises a wireless communication module that enables the data processing system 310 to communicate with one or more external data processing systems via a wireless external network 360, using a wireless data protocol made available in the external network 360.

In one embodiment, the data processing system 310 comprises a wireless communication module that enables the data processing system 310 to communicate wirelessly via a local network 330, using a wireless data protocol made available in the local network 330 (e.g., a WiFi protocol). The local network 330 may include both wireless and wireline connections (e.g., may permit communications using both WiFi and Ethernet protocols). In one embodiment, the local network 330 may consist of two or more networks, whether wireless or wired, and the two or more networks may operate independently (e.g., to increase security by separating communications) or may be connected to each other (e.g., to facilitate communications among devices connected to different networks).

In one embodiment, the external network 360 could provide a connection to the Internet for the data processing system 310, and the data processing system 310 could act as a gateway to the Internet for the networking device 380 and for other local data processing systems or peripheral devices that are connected to the networking device 380.

In one embodiment, the data processing system 310 may communicate with a remote commerce server or back-end portal 370 via the external network 360. In various embodiments, the back-end portal 370 may be a portal that is stored in a cloud or on a remote commerce server. In various embodiments, the back-end portal 370 may assist the data processing system 310 to conduct or facilitate a commercial transaction. In one embodiment, the back-end portal 370 is the back-end portal 170 from the embodiment of FIG. 1.

In various embodiments, the external network 360 is a network that facilitates communications at longer distances. In various embodiments, the external network 360 is, or includes, a 3G network, a 4G network, an EDGE network, a CDMA network, a GSM network, a 3GSM network, a GPRS network, an EV-DO network, a TDMA network, an iDEN network, a DECT network, a UMTS network, a WiMAX network, a cellular network, any type of wireless network that uses a TCP/IP protocol or other type of data packet or routing protocol, any other type of wireless wide area network (WAN) or wireless metropolitan area network (MAN), or a satellite communication channel or network. Each of the foregoing types of networks that could be used within the external network 360 utilizes various communication protocols, including protocols for establishing connections, transmitting and receiving data, handling various types of data communications (e.g., voice, data files, HTTP data, images, binary data, encrypted data, etc.), and otherwise managing data communications. In various embodiments, the data processing system 310 is configured to be compliant with one or more protocols used in the external network 360, such that the data processing system 310 can successfully connect to the external network 360 and communicate via the external network 360.

In one embodiment, the data processing system 310 further comprises a wireless communication module that enables the data processing system 310 to communicate with the networking device 380 via a personal area network. As an example, a personal area network may be implemented via a Bluetooth protocol.

In one embodiment, the networking device 380 is adapted to communicate with one or more other local data processing systems, illustrated in FIG. 3 as data processing system 322, and with one or more local peripheral devices, illustrated in FIG. 3 as peripheral device 320. In various embodiments, the networking device 380 may be adapted to communicate using a wired connection, such as a serial connection, a parallel connection, a wired packet-based communication protocol (e.g., Ethernet, USB, FireWire, etc.), and/or any other wireline connection protocol. In various embodiments, the networking device 380 may be adapted to communicate using a wireless connection, such as a WiFi connection.

In one embodiment, the networking device 380 is adapted to handle data communications via the local network 330 with one or more local data processing systems and/or peripheral devices, such as the data processing system 322 and the peripheral device 320. In one embodiment, the networking device 380 establishes the local network 330 and the data processing system 322 and the peripheral device 320 join this local network 330. In another embodiment, the local network 330 is established by another device (e.g., by another wireless and/or wired router, by any data processing system, by any peripheral device, etc.), and the wireless router 330, the data processing system 322, and/or the peripheral device 320 join the local network 330.

In various embodiments, the local network 330 is a wireless network that facilitates wireless communications between devices that are collocated within a room, building, facility, location, or that are otherwise disposed in a local configuration. For example, the local network 330 may be created within a commercial establishment where a commercial transaction mediated by the data processing system 310 will take place, such as a restaurant, store, hotel, gas station, school, employment location, or other business facility.

In various embodiments, the local network 330 may be a WiFi network, including any wireless network compliant with an IEEE 802.11 standard, any wireless network for local wireless communications developed by or with the assistance of the WiFi Alliance or other standard bodies or industry groups, or any other wireless local area network. In general, for various embodiments, the local network 330 is preferably a communication network that is capable of establishing reliable wireless connections between two or more data processing devices even if they are not in immediate proximity. For example, the local network 330 would preferably be able to establish and maintain reliable wireless connections between devices separated by each other by more than 1 meter, more than 5 meters, more than 10 meters, more than 15 meters, more than 20 meters, more than 25 meters, more than 30 meters, more than 35 meters, more than 40 meters, more than 45 meters, more than 50 meters, or even longer. Some WiFi networks are known to operate reliably at distances of over 100 meters, depending on the environment.

In general, in residential or business environments where the devices connected to the local network 330 are separated by multiple walls or other objects, the range of reliable wireless communications within the local network 330 decreases. In contrast, in more open environments, such as a restaurant or grocery story with wide open areas, the range of reliable wireless communications within the local network 330 increases. In most embodiments, it is not necessary for the local network 330 to be able to accommodate reliable wireless communications within the local network 330 at distances of more than 100 meters. If the range of the local network 330 is too low, the local network 330 can be improved by adding one or more additional wireless routers or other range expanding devices, such that the size or shape of the local network 330 is appropriately increased.

In various embodiments, the reliability of the communications between the data processing system 310 and the external network 360 may be important. For example, in various embodiments, the data processing system 310 may be conducting POS transactions that require transmission of data to a remote device or server (e.g., payment data, SKU-level data, loyalty information, or any other transaction data, etc.), may be collecting transactions or other data produced on the local network 330 and transmitting them to one or more devices connected to the external network 360, may be facilitating individual transactions taking place within the local network 330 by routing them to the remote commerce server 370 through the external network 360, or may be acting as a local commerce server at the point of sale and be configured to transmit critical aggregate transaction information or backup data to a remote device via the external network 360. In any of these cases or in other similar situations, it is desirable to design a network topology that enhances the ability of the data processing system 310 to reliably transmit information through the external network 360.

In one embodiment, the data processing system 310 comprises a wireless module that enables it to join wirelessly the local network 330 and/or to connect wirelessly with the networking device 380. In such deployments, the data processing system 310 could establish a wireless connection with the local network 330 and/or with the networking device 380, and through such network and/or networking device it could also connect with any of the local data processing systems or peripheral devices, such as the data processing system 322 and the peripheral device 320.

It is often advantageous for a data processing system 310 to communicate with the local network 330 and/or with the networking device 380 using a wireless protocol. For example, a wireless connection may permit the data processing system 310 to be easily relocated, or to be used in a mobile or portable configuration. As another example, a wireless network connection may remove the need for a network cable to be connected to the data processing system 310, which may reduce cost, increase convenience and/or provide other benefits.

There are situations, however, when it may be preferable to connect the data processing system 310 via a wireline connection. For example, when an environment is experiencing significant interference with wireless communications (e.g., interference from other wireless devices), when the separation between the device and the wireless networking equipment is too large (e.g., such that the wireless signals become too weak), or when significant obstacles are interfering with wireless communications (e.g., if metallic objects, thick walls or other physical obstacles are interfering with the propagation of wireless signals), a wireline connection may be more reliable to support data communications of the data processing system 310. Also, in certain situations, security or client requirements may require that communications be performed through wireline (i.e., non-wireless) connections, and thus, in embodiments, the processing device may be limited to allow only wireline communications.

As another example, connecting the data processing system 310 through a wireless connection directly to the local network 330 may not be desirable if the reliability of communications within the local network 330 decreases. In that case, the ability of the data processing system 310 to conduct or facilitate POS transactions and/or to conduct other communications with devices connected to the local network 330 could be negatively affected. Connecting the data processing system 310 to the networking device 380 through a wired connection may improve the reliability of communications for the data processing system 310.

Other examples of cases where it may be less desirable to connect the data processing system 310 wirelessly with devices connected to the local network 330 (e.g., the peripheral device 320 and the data processing system 322) and/or with devices connected to the external network 360 (e.g., the central server 370), and where a wired connection between the data processing system 310 and the networking device 380 and/or the local network 330 may be preferable, include the following:
when the number of peripheral devices and/or data processing systems connected to the local network 330 wirelessly increases too much, wireless communications within the local network 330 may become unreliable;
in some cases, the communication capabilities of the data processing system 310 may be negatively impaired when both the wireless module connecting to the external network 360 and the wireless module connecting to the local network 330 are turned on; this may happen due to design limitations within the data processing system 310, interference between the wireless modules of the data processing system 310 that connect to the local network 330 and respectively the external network 360, and other communication artifacts or problems;
in some cases, there may be a high density of local wireless networks that overlap at the geographical location where the data processing system 310 is located, as is often the case in dense urban or commercial environments. In such cases, it is possible for the reliability of the communications across the local network 330 to be negatively affected. While some negative reliability or data transmission throughput impact may be acceptable in some implementations for the data processing system 322 or the peripheral device 320 connected to the local network 330, such a negative impact on the reliability or throughput of the data processing system 310 may not be acceptable.
in some cases, the networking device 380 could be designed to more reliably and/or securely route and/or manage data traffic through the local network 330 that is addressed to, or received from the data processing system 310, as opposed to having that traffic directly reaching the data processing system 310. This may be the case, for example, when the data processing system 310 is a small form factor tablet or other device with reduced processing power or with less robust network management capabilities, or when the data traffic management functionality may be more efficiently managed in a dedicated separate networking device.

Another reason why connecting the data processing system 310 wirelessly to the local network 330 and/or to the networking device 380 may not be desirable is to enhance the security protection of the data processing system 310. For example, by connecting the data processing system 310 wirelessly to the local network 330, the data processing system may be exposed to additional security threats from devices that can access the local network 330 or that are otherwise able to spoof or simulate the identity of a trusted device permitted to connect to the local network 330. In such cases, the security of the data processing system 310 could be improved in one embodiment by deploying a dedicated networking device, such as the networking device 380, between the data processing system 310 and the local network 330, and by connecting the data processing system 310 to the networking device 380 with a wired connection. In such an embodiment, the networking device 380 could manage security credentials of devices connected to the local 330, could provide a firewall, could filter traffic through another layer of security, and/or could otherwise be configured to control the communications between such devices and the data processing system 310.

In one embodiment, the wireless module of the data processing system 310 that is able to communicate in frequency ranges compatible with those used by the local network 330 is completely turned off. Consequently, in this embodiment, the data processing system is protected against security threats posed by wireless device using such frequency ranges, as long as the respective wireless module remains turned off. Consequently, the security of the data processing system 310 is significantly enhanced, and the data processing system 310 may be connected to the networking device 380 with a wired connection to permit data transmissions from and to the data processing system 310.

In one embodiment, the data processing system 310 comprises a data port 312, which enables the data processing system 310 to communicate using a wireline (wired) connection. Examples of such wireline connections are a serial connection, parallel connection, wired packet-based connection (e.g., Ethernet, USB, FireWire, etc.), or other wired connection.

In various embodiments, the data port 312 may be directly compatible with the wired connections and protocols offered by the networking device 380. For example, the networking device 380 may include a commercially available Ethernet data port, a USB data port, a FireWire data port, and/or any other data port that is available commercially, and the data port 312 may be compatible with such data port. In such embodiments, the data processing system 310 would be able to communicate directly with the networking device 380 via a wired connection using the common protocol.

In some embodiments, however, the data port 312 does not directly support a protocol that is available in the networking device 380. In such situations, an alternative solution must be found to reliably connect the data processing system 310 and the networking device 380 via a wired connection. For example, the data processing system 310 may support a serial port or a parallel port, but may not directly support an Ethernet connection, while the networking device 380 may include an Ethernet port but may not have a serial or parallel port.

In one embodiment, an adapter device, denoted as data adapter 390, is used to connect to both the data processing system 310 and to the networking device 380. In this embodiment, the data adapter 390 may be designed or selected to be compatible with one or more protocols supported by the data processing system 310 and with one more protocols supported by the networking device 380, and to facilitate communications between the data processing system 310 and the networking device 380. In this embodiment, the data adapter 390 is configured to convert and/or reroute data formatted in accordance with one or more protocols supported by the data processing system 310 and one more protocols supported by the networking device 380.

In one embodiment, the data processing system 310 is configured to refuse communications with various devices unless certain conditions are met. In one embodiment, the data processing system 310 does not establish a connection for data transmissions with the data adapter 390 unless the data processing system 310 receives a proper authentication signal from the data adapter 390. In one embodiment, the data adapter 390 includes an authorization logic module that is configured to authorize communications with the data processing system 310.

In one embodiment, the data processing system 310 limits the scope, duration, level of trust or other characteristic of a connection with the data adapter 390 unless the data processing system 310 receives a proper authentication signal from the data adapter 390. In one embodiment, the data processing system 310 limits the type of data transmitted to and/or received from the data adapter 390 unless the data processing system 310 receives a proper authentication signal from the data adapter 390.

In various embodiments, the authorization logic module incorporated in the data adapter 390 is or includes an authorization coprocessor, a secure cryptoprocessor/coprocessor, a dongle, or a smart card (e.g., an authorization secure smart card). In various embodiments, the authorization logic module is or includes a software logic module. In various embodiments, the authorization logic module is or includes a hardware logic module. In various embodiments, the authorization logic module is or includes a combination of software and hardware.

In various embodiments, the data processing system 310 and/or the data adapter 390 do not establish a connection for sustained data transmissions unless the other device complies with a predetermined authorization process (e.g., a data access control scheme or framework). Examples of such authorization processes include validation of a security credential, correct transmission or exchange of an encryption key, pairing via a key or pin exchange mechanism, proper response to a security challenge, valid entry of a username and/or password, or any other authentication approach relying on one or more authenticators to establish the identity of an originator or receiver of information.

In one embodiment, the data processing system 310 is an iPad tablet or other device commercialized by Apple, Inc., and the authorization logic module comprised in the data adapter 390 is an authentication coprocessor commercialized and/or licensed by Apple, or otherwise compatible with devices manufactured, commercialized or licensed by Apple. In this embodiment, before establishing a connection for sustained communications with the data adapter 390, the data processing system 310 checks for the presence of the authorization logic module and validates the security credentials of the data adapter 390. In embodiments, the data processing system 310 may be a closed system, in which restrictions exist regarding: which applications may operate on the system; which applications or devices may interface or communicate with the system; how applications or devices may interface or communicate with the system; which type or types of ports exists on the system, such as propriety or non-standardized ports; or combinations thereof.

In various embodiments, the data adapter 390 includes a first data port configured to communicate using a first communication protocol and a second data port configured to communicate using a second communication protocol.

In various embodiments, the first data port may be a serial port, a parallel port, a USB port, an Ethernet port, a FireWire port, a Lightning port, a fiber optic port, or any other port using wireline technology or using a wired communication protocol, whether proprietary or industry standard. The first data protocol may be any protocol compatible with the first data port. In various embodiments, the second data port may be a serial port, a parallel port, a USB port, an Ethernet port, a FireWire port, a Lightning port, a fiber optic port, or any other port using wireline technology or using a wired communication protocol, whether proprietary or industry standard. The second data protocol may be any protocol compatible with the second data port.

In one embodiment, the first data port included in data adapter 390 is a serial port that is compatible with a data port available on an Apple iPad device, Apple iPod, Apple iPhone, other Apple device, Android device, or other data processing system. In one embodiment, the second data port included in data adapter 390 is an Ethernet port that can support Ethernet connections, a USB port, a serial port, or another data port (whether industry standard or proprietary).

For example, iPad devices that are commercialized by Apple as of April 2015 include a data port that supports communications using a serial protocol, but do not include an Ethernet port. The data port available on an iPad may be the data port 312 from FIG. 3.

In one embodiment, the first data port included in data adapter 390 is or includes a serial port that can communicate with an iPad device using a serial protocol, and the second data port is or includes an Ethernet port that can communicate with an Ethernet port included in the networking device networking device 380. In this embodiment, the data adapter 390 may be designed or configured to convert communications between the serial protocol supported by the Apple device deployed as data processing system 310 and between the Ethernet protocol supported by the networking device 380. In one embodiment, the first data port may additionally include a set of power pins that can be used power the data processing system 310 while a serial connection is established between the data adapter 390 and the data processing system 310.

For example, in one embodiment, an Apple iPad tablet device is deployed as the data processing system 310 and a cable is connected between the first data port of the data adapter 390 and a port of the Apple device, and this cable is used to both power the Apple device and to conduct serial communications between the Apple device and the data adapter 390. In embodiments, a cable may be used to connect via a wired connection, such as a Lightning connection, to the iPad at one end of the connector (or cable) and an RS-232 or other serial connection at the other end of the connector. Such a cable/connector is available from Redpark Product Development of Emeryville, Calif. In various embodiments, other tablets or similar devices could be deployed in place of the Apple iPad tablet, and the cable connection would be suitable modified to fit the ports available on such other tablets or devices.

In embodiments, the second data port of the data adapter 390 may be connected to the networking device 380 via an Ethernet or USB cable, and the data adapter 390 may facilitate communications between the Apple device and the networking device 380 while the Apple device is powered. In various related embodiments, the data processing system 310 may be a device other than an Apple device, such as an Android tablet or other electronic device that has to be powered while conducting communications via the data adapter 390.

In embodiments, conversion between the serial communication from the data processing system 310 and the second communication protocol may be performed by the data processing system 310, the data adapter 390, or a combination thereof. For example, in embodiments, a component or module operating on data processing system 310 or the data adapter 390 may make one or more calls to the drivers for COM settings for one or more peripherals (e.g., devices interfaced with USB ports on the data adapter 390 or via an Ethernet/TCP interfaced to a networked IP address). The data processing system 310, the data adapter 390, or a combination thereof, may log or otherwise track the identified peripheral devices and use this information when communicating with a devices or devices.

For example, in embodiments, a unique identifier may be associated with each peripheral devices that communicates with the data processing system 310. This may be a universally unique identifier (UUID), an Internet Protocol (IP) address, a Media Access Control (MAC) address, or some other identifier. In embodiment, the data processing system 310 may encode within the serial communication the unique identifier of the intended recipient, and the data adapter 390 receives this serial communication and uses the unique identifier to identify the intended recipient, converts the serial communication into a second protocol format (e.g., USB or Ethernet), and addresses or directs the format-converted data so that the correct device receives that communication. In embodiments, the unique identifier may be destination address for the intended recipient device and the destination address may be used by the data adapter to address one or more Ethernet packets to the recipient device. In embodiments, if the identifier used in the serial data for a networked device is not an IP address, the data adapter may perform a look-up process by maintaining and using a device_ID-to-IP_address table to correlate the device identifier with its networked IP address so that an Ethernet packet may be formed and properly addressed. In embodiments, the data adapter, the data processing system, or both may maintain destination address information, source address information, or both and use such information for identifying communications to and/or from devices.

It should be noted, that in like manner as described above, in embodiments, data received from the peripheral devices is be converted to serial communication to be received by the data processing device. In such embodiments, the serial communication may be encoded with an identifier that indicates the original source of the data.

In various embodiments, powering an iPad or other data processing system through a data port is done via a set of power pins included in the data port. In one implementation, the set of pins may include a dedicated power pin to provide power and a dedicated ground pin for ground. In one implementation, the set of pins may include a dedicated power pin to provide power and a pin that is used both to provide a ground level for power and for other purposes (e.g., that pin may also serve as a ground pin for data transmissions). In various embodiments, pins included in the data processing system 310 and/or data adapter 390 may be used to perform multiple functions.

In various embodiments, the data processing system 310 may be any tablet or other computing device, including any tablet or device running an Android, Chrome, Windows or other operating system, and the data port 312 may be, or may include a serial port, USB port, parallel port, Ethernet port or any other physical port. The port may be following an industry standard or may be using a proprietary design. In such embodiments, the data adapter 390 includes a data port that is compatible with the ports provided by such tablets or other devices, so that the data adapter 390 can be connected via a wired connection to the data processing system 310. In various embodiments, there may be an additional converter that is introduced between the data adapter 390 and the data processing system 310 to further facilitate the physical, mechanical or electrical compatibility between the data port available on the data processing system 310 and the data adapter 390.

In various embodiments, the data processing system 310 is a desktop computer, an electronic tablet (e.g., an iPad device, a tablet running the Android operating system, etc.), a miniature tablet (e.g., an iPad mini device), a laptop, an ultrabook, an electronic reader, or a smartphone. In one embodiment, the data processing system 310 is a stationary computer (e.g., a desktop computer, or a mobile computer that has been converted into a stationary computer (e.g., by being locked down or attached to a more permanent stand)).

One challenge with connecting to data ports included in devices commercialized by some manufacturers is to simultaneously power those devices and accommodate data transmissions.

In one embodiment, the data adapter 390 is designed or configured to connect via a cable to a set of power pins of the data port 312 and at the same time to also facilitate communications via a set of pins of the data port 312. For example, the connector available on the iPad device includes a set of pins through which the iPad device may be powered, and a set of pins through which the iPad may transmit and/or receive data using a serial protocol. The proper pins for power and data transmissions may be determined by reference to applicable specifications or through engineering analysis (e.g., by analyzing the input/output profile of the data received or transmitted by the iPad device, by attempting to power and/or communicate with the device by trial and error, etc.). There are known engineering methods in the art for analyzing or otherwise reverse engineering data ports and interfaces of electronic devices. In one embodiment, the data port 312 included in an Apple iPad device has 8 pins for a Lightning connector, and these 8 pins comprise a set of pins for serial data communications and a set of pins for powering the device. One or more pins may also be used to detect or determine an insertion format for the Lightning connector such that the connector/cable may be inserted in first position or in an inverted or reverse position but may still function the same in either case.

In one embodiment, the data adapter 390 is a Raspberry Pi device commercialized by the Raspberry Pi Foundation, although other computing devices may also be used. In one embodiment, the Raspberry Pi device, which is deployed as data adapter 390, is connected via a serial connection to an iPad device, which is deployed as data processing system 310, through a set of data pins included in data port 312. In this embodiment, the Raspberry Pi device is also powering the iPad device through a set of power pins included in the data port 312. In this embodiment, the Raspberry Pi device is further connected to a networking device, deployed as networking device 380, through an Ethernet port. As an alternative to the Ethernet port, the Raspberry Pi device may be connected to the networking device 380 through a USB port or another data port that can be recognized (directly or through additional processing or conversion) by the networking device 380.

In various embodiments, the data processing system 322 is a device substantially similar with the data processing system 310, or is any other type of data processing system (e.g., a tablet computer, an iPad, a tablet or computer running the Android operating system, a laptop, an ultrabook, an electronic reader, a smartphone, etc.).

In various embodiments, the peripheral device 320 can be any one of the following: a cash register, a coin dispenser, a credit card reader, a barcode scanner, a printer, a document scanner, an RFID receiver configured to receive payment-related information from an RFID-enabled device, an image recognition device capable of identifying an object, a photo camera, or a video camera. In various embodiments, there may be two or more peripheral devices, such as the peripheral device 320, directly or indirectly attached to the local network 330 and in communication with the networking device 380.

In various embodiments, a point of sale system such as the point of sale system shown in FIG. 3, is deployed in a commercial establishment, such as a sit-down (table) restaurant, quick service restaurant, retail store, hotel, gas station, bank or other financial institution, school, employment location, or other business facility, to facilitate a commercial transaction.

In one embodiment, the commercial transaction may be a restaurant or other food-related transaction, and to conduct such a transaction the data processing system 310 and the peripheral device 320 may exchange information such as the following: an identification marker of a food item, a price of a food item, an identification marker of a beverage item, a price of a beverage item; a price of a meal, or any other information that is relevant to the operation or management of a restaurant or similar commercial establishment.

In one embodiment, the commercial transaction may be a sale of an item, and to conduct such a sale transaction, the data processing system 310 and the peripheral device 320 may exchange information, such as the following: a price of the item, an identification marker of the item, or any other information that is relevant to the operation or management of a store or similar commercial establishment.

This specification describes in detail various embodiments and implementations of the present invention, and the present invention is open to additional embodiments and implementations, further modifications, and alternative and/or complementary constructions. There is no intention in this patent to limit the invention to the particular embodiments and implementations disclosed; on the contrary, this patent is intended to cover all modifications, equivalents and alternative embodiments and implementations that fall within the scope of the claims.

As used in this specification, a set means any group of one, two or more items. Analogously, a subset means, with respect to a set of N items, any group of such items comprising N−1 or less of the respective N items.

As used in this specification, the terms “include,” “including,” “for example,” “exemplary,” “e.g.,” and variations thereof, are not intended to be terms of limitation, but rather are intended to be followed by the words “without limitation” or by words with a similar meaning. Definitions in this specification, and all headers, titles and subtitles, are intended to be descriptive and illustrative with the goal of facilitating comprehension, but are not intended to be limiting with respect to the scope of the inventions as recited in the claims. Each such definition is intended to also capture additional equivalent items, technologies or terms that would be known or would become known to a person of average skill in this art as equivalent or otherwise interchangeable with the respective item, technology or term so defined. Unless otherwise required by the context, the verb “may” or “could” indicates a possibility that the respective action, step or implementation may or could be achieved, but is not intended to establish a requirement that such action, step or implementation must occur, or that the respective action, step or implementation must be achieved in the exact manner described.

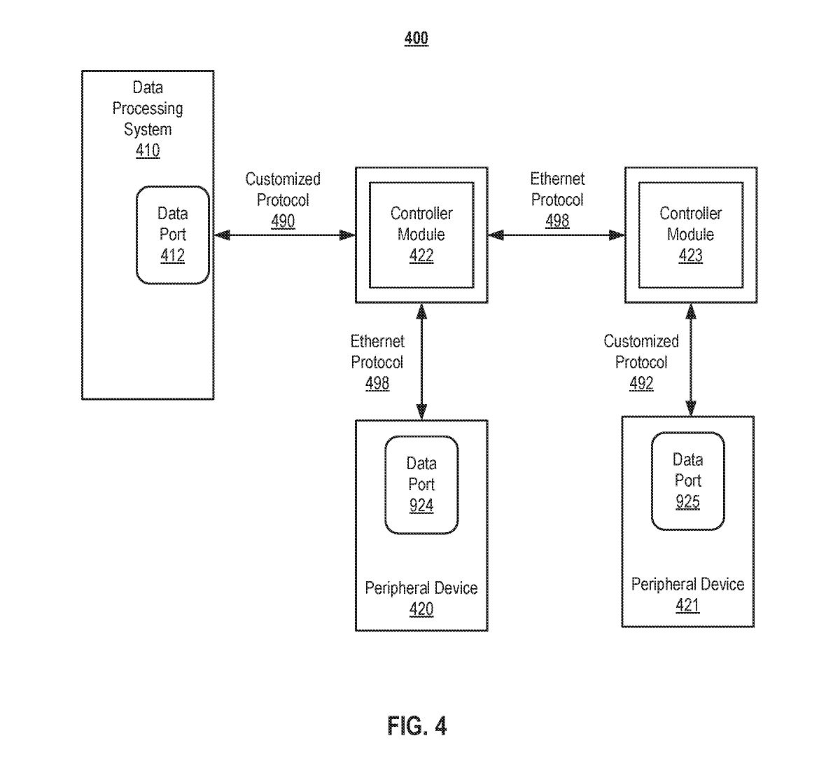

FIG. 4 illustrates one or more peripheral devices communicating with a data processing system using data converted between customized data protocols and a standardized communication protocol in accordance with an embodiment.

In the embodiment of FIG. 4, a peripheral device 420 communicates with a data processing system 410. In one embodiment, the peripheral device 420 is the peripheral device 120 from the embodiment of FIG. 1. In one embodiment, the data processing system 410 is the data processing system 110 from FIG. 1.

In the embodiment of FIG. 4, a second peripheral device 421 communicates with the data processing system 410. In one embodiment, the peripheral device 421 is the peripheral device 120 from the embodiment of FIG. 1.

The two peripheral devices 420 and 421 are shown in FIG. 4 for illustration purposes, to exemplify various embodiments, but either of the two devices 420 and 421 may be omitted. Analogously, in various embodiments, additional devices that are similar to the devices 420 and 421 may be connected to the data processing system 410. In one embodiment, there may be multiple data processing systems similar to the data processing system 410 and devices that are similar to the devices 420 and 421.

In one embodiment, data transmissions between the peripheral device 420 and the data processing system 410 take place directly, through a direct communication channel.

In one embodiment, data transmissions between the peripheral device 420 and the data processing system 410 are routed through a controller module 422, which facilitates conversion of data from a first data protocol to an intermediate data protocol.

In one embodiment, the first data protocol is a customized protocol that can be directly processed by the data processing system 410, which is denoted in FIG. 4 as the customized protocol 490. In one embodiment, the customized protocol 490 is a protocol that may be processed through a connector that is implemented on an iPad tablet device commercialized by Apple Computer, Inc. In various embodiments, the customized protocol 490 may be any serial, parallel, or packet-based communication protocol that can be used by a data processing system or logic module to transmit or receive information.

In one embodiment, the intermediate data protocol is a communication protocol that is in widespread use in the industry, such as any communication protocol (whether low level, high level, backbone or otherwise) used in any communication channel or data network, including LANs, MANs, WANs, cellular and mobile telephony networks, the Internet or the World Wide Web. In the embodiment of FIG. 4, the intermediate data protocol is shown to be an Ethernet protocol and is denoted Ethernet protocol 498.

Advantages for using an intermediate data protocol that is standardized or is designed for longer distance communications include decreased costs, availability of standardized interface modules, availability of preinstalled cabling and communication lines, increased reliability for data communications, better ability to track and address communication errors, and others.

In one embodiment, the controller module 922 is a Serial-to-Ethernet (S2E) Module model MDL-S2E commercialized by Texas Instruments. One application for the MDL-S2E module that is specified by Texas Instruments is to facilitate Ethernet communications for devices that lack built-in Ethernet connectivity but have a UART or RS-232 port. In various embodiments, a conversion module such as this S2E module may be adapted to convert data from a first communication protocol used by the data processing system 410 to an intermediate widely used communication protocol, denoted in FIG. 4 as Ethernet protocol 498.

In various embodiments, the controller module 422 may be integrated within the data processing system 410, may be attached or otherwise connected to the data processing system 410, or may be deployed remotely (alone or integrated in a data processing system or logic module) such that communications from the data processing system 410 and intended for the peripheral device 420 and/or peripheral device 421 are routed through the controller module 422.

In the embodiment of FIG. 4, the peripheral device 420 comprises a data port that is configured to transmit and receive data formatted in accordance with the intermediate data protocol. For the embodiment of FIG. 4, the second data protocol is illustrated as the Ethernet protocol 498, so the data port shown as incorporated within the peripheral device 420 is an Ethernet port, denoted as Ethernet port 424. In one embodiment, the Ethernet port 424 is not incorporated in the peripheral device 420, but may be attached or otherwise connected to the data peripheral device 420, or may be deployed remotely (alone or integrated in a data processing system or logic module) such that communications from the controller module 422 and intended for the peripheral device 420 are routed through the Ethernet port 420.

In one embodiment, the peripheral device 421 is similar to the peripheral device 420, but does not comprise an Ethernet port. Instead, the peripheral device 421 comprises a data port that communicates using a customized protocol, not directly compatible with more widely used communication protocols, such as the Ethernet protocol 498 shown in FIG. 4. Consequently, communications formatted in accordance with the Ethernet protocol 498 are routed through a controller module 423. In one embodiment, the controller module 423 is incorporated in the peripheral device 421. In one embodiment, the controller module 423 is not incorporated in the peripheral device 421, but may be attached or otherwise connected to the data peripheral device 421, or may be deployed remotely (alone or integrated in a data processing system or logic module) such that communications from the controller module 422, from the data processing system 410, and or from other data processing systems or data processing modules and intended for the peripheral device 421 are routed through the controller module 423.

In one embodiment, the controller module 422 converts a first customized data protocol to an intermediate protocol that is a TCP/IP protocol compatible with an Ethernet data communication, and the controller module 423 converts an intermediate protocol that is a TCP/IP protocol compatible with an Ethernet data communication to a second customized data protocol. In one embodiment, the first and second customized data protocols are the same, or are compatible with each other. In one embodiment, the first and second customized data protocols are different and are not directly compatible with each other.

In one embodiment, the data port 425 of the peripheral device 421 is compatible with a 9-pin DB9 (sometimes denoted DE9) connector. In one embodiment, a cable that connects the controller module 423 to the data port 425 has DB9 connectors at both ends. In one embodiment, a cable that connects the controller module 423 to the data port 425 has an Ethernet connector at the end of the controller module 423 and a DB9 connector at the end of the data port 425. In one embodiment, the controller module 423 is powered through a pin of the cable that attaches the controller module 423 to the peripheral device 421, with the peripheral device 421 supplying the power for the controller module 423 to operate.

In one embodiment, the data port 412 of the data processing system 410 is an iPad (or other electronic tablet) data connector. In one embodiment, a cable that connects the controller module 422 to the data port 412 has iPad (or other electronic tablet) connectors at both ends. In one embodiment, a cable that connects the controller module 422 to the data port 412 has an Ethernet connector at the end of the controller module 422 and an iPad (or other electronic tablet) data connector at the end of the data processing system 410. In one embodiment, the controller module 422 is powered through a pin of the cable that attaches the controller module 422 to the data processing system 410, with the data processing system 410 supplying the power for the controller module 422 to operate.

In one embodiment, the data processing system 410 transmits or receives specific operational instructions or data communications to or from the peripheral device 421. If the customized protocols 490 and 492 are not directly compatible, the controller module 422 converts data formatted in accordance with the customized protocol 490 into an intermediate protocol (e.g., the Ethernet protocol 498), and the controller module 423 converts data formatted in accordance with the intermediate protocol (e.g., the Ethernet protocol 498) into data formatted in accordance with the customized protocol 492.

In one embodiment, the peripheral device 421 may be programmed to interpret the operational instructions or data communications sent by the data processing system 410, and to transmit instructions and data to the data processing system 410. In one embodiment, the peripheral device 421 includes an application programming interface (API) or is compatible with an API that permits the peripheral device 421 to be programmed to interpret the operational instructions or data communications received from the data processing system 410, and to transmit instructions and data to the data processing system 410.

In one embodiment, the peripheral device 421 is a coin dispenser that is in communications with an iPad tablet deployed as the data processing system 410. The coin dispenser may be configured to release coins to customers in a POS retail environment (e.g. to provide change in a grocery store). The coin dispenser may receive specific instructions from the iPad tablet to dispense various combinations of coins, and the coin dispenser may communicate back to the iPad tablet various data regarding its status (e.g., indicating that a certain type of coins are being depleted, acknowledging successful coin dispensing operations, etc.).

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

It will be appreciated that the preceding examples and embodiments are exemplary and are for the purposes of clarity and understanding and not limiting to the scope of the present invention. It is intended that all alternatives, permutations, enhancements, equivalents, combinations, and improvements thereto that are apparent to those skilled in the art, upon a reading of the specification and a study of the drawings, are included within the scope of the present invention. It is therefore intended that the claims include all such alternatives, permutations, enhancements, equivalents, combinations, and improvements that fall within the true spirit and scope of the present invention, unless the following claims by their language expressly state otherwise.

What is claimed is:

1. A data adapter comprising:
a first port for communicatively connecting via a connector with a data processing system to communicate with the data processing system using a serial data communication protocol;
a security coprocessor that facilitates authentication with the data processing system to enable interactions with the data processing system;
a second port for communicatively connecting with a second device to communicate with the data processing system using a second data communication protocol; and
at least one processing component that converts communications between the serial data communication protocol supported by the data processing system and the second data communication protocol.

2. The data adapter of claim 1 wherein the data processing system is at least one of an iPad® device by Apple, Inc. and a non-Apple, Inc. tablet device.

3. The data adapter of claim 2 wherein the iPad® device is operating as a point-of-sale device and is limited to communicating via a wired connection.

4. The data adapter of claim 1 wherein the second data communication protocol is an Ethernet protocol and the at least one processing component converts communications between the serial data communication protocol supported by the data processing system and Ethernet protocol by causing steps to be performed comprising: identifying within a serial communication received from the data processing system a unique identifier that identifies an intended recipient of the serial communication and formatting the serial communication into one or more Ethernet packets with a header that contains a destination address to allow the intended recipient to receive the one or more Ethernet packets.

5. The data adapter of claim 4 wherein the unique identifier that identifies an intended recipient of the serial communication is used in a look-up process to identify a destination address for the intended recipient of the serial communication.

6. The data adapter of claim 1 wherein the second device is a peripheral device and the data adapter is further configured with a peripheral device driver for the peripheral device.

7. The data adapter of claim 6 wherein the peripheral device is at least one of:
a credit card reader;
a barcode scanner;
a radio frequency identification (RFID) receiver configured to receive payment-related information from an RFID-enabled device;
an image recognition device capable of identifying an object or person;
a photo camera; and
a video camera.

8. A point-of-sale (POS) system for facilitating processing of a transaction, the point-of-sale system comprising:
a data processing system comprising:
at least one processor and memory for processing data associated with a transaction and that facilitates authentication with the data processing system to enable interactions with the data processing system; and
a first port for communicatively connecting via a connector; and
a data adapter comprising:
a first port for communicatively connecting via a connector with the first port of the data processing system to communicate with the data processing system using a serial data communication protocol;
a security coprocessor that facilitates authentication with the data processing system to enable interactions with the data processing system;
a second port for communicatively connecting with a second device to communicate with the data processing system using a second data communication protocol; and
at least one processing component configured to convert communications between the serial data communication protocol supported by the data processing system and the second data communication protocol.

9. The point-of-sale (POS) system of claim 8 wherein the data processing system is an iPad® device by Apple, Inc. and the iPad® device is limited to communicating via a wired connection.

10. The point-of-sale (POS) system of claim 8 wherein the second data communication protocol of the data adapter is an Ethernet protocol and the data processing system includes within a serial communication a unique identifier that identifies the intended recipient device of the serial communication.

11. The point-of-sale (POS) system of claim 10 wherein the unique identifier is an Ethernet destination address for the intended recipient device.

12. The point-of-sale (POS) system of claim 8 wherein the second data communication protocol of the data adapter is an Ethernet protocol and the at least one processing component of the data adapter converts communications between the serial data communication protocol supported by the data processing system and Ethernet protocol by causing steps to be performed comprising: identifying within a serial communication received from the data processing system a unique identifier that identifies an intended recipient of the serial communication and formatting the serial communication into one or more Ethernet packets with a header that contains a destination address to allow the intended recipient to receive the one or more Ethernet packets.

13. The point-of-sale (POS) system of claim 12 wherein the unique identifier that identifies an intended recipient of the serial communication is an Ethernet destination address for the intended recipient of the serial communication.

14. The point-of-sale (POS) system of claim 12 wherein the unique identifier that identifies an intended recipient of the serial communication is used by the data adapter in a look-up process to identify a destination address for the intended recipient of the serial communication.

15. The point-of-sale (POS) system of claim 8 wherein the data adapter supplies power to the data processing system via at least one pin in the 8-pin connector.

16. A computer-implemented method for facilitating interaction between a data processing system with a serial data communication interface and a second device using a second data communication protocol, the method comprising:
authenticating with the data processing system using a security coprocessor;
responsive to receiving serial data from the data processing system via a connector:
identifying, from within at least some of the serial data, a second device that is an end recipient of data from the serial data;
converting at least a portion of the serial data into data in a second data protocol format, the data in the second data protocol format being addressed to the second device; and
transmitting the data in the second data protocol format via a second port to the second device.

17. The computer-implemented method of claim 16 wherein the second data communication protocol of the data adapter is an Ethernet protocol.

18. The computer-implemented method of claim 16 wherein the data processing system is an iPad® device by Apple, Inc.

19. The computer-implemented method of claim 18 wherein the iPad® device is limited to communicating via a wired connection.

20. The computer-implemented method of claim 16 wherein the second device is at least one of:
a credit card reader;
a barcode scanner;
a radio-frequency identification (RFID) receiver configured to receive payment-related information from an RFID-enabled device;
an image recognition device capable of identifying an object or person;
a photo camera; and
a video camera.
